(19) United States
(12) Patent Application Publication
(10) Pub. No.: US 2008/0013464 A1
(43) Pub. Date: Jan. 17, 2008

(54) Method and system for blocking the specific function of the P2P application in the network

(75) Inventors: Nen-Fu Huang, Hsin-Chu (TW); Yuan-Fang Huang, Taipei City (TW)

Correspondence Address: BIRCH STEWART KOLASCH & BIRCH, PO BOX 747, FALLS CHURCH, VA, 22040-0747, US

(73) Assignee: BroadWeb Corporation

(21) Appl. No.: 11/822,626

(22) Filed: Jul. 9, 2007

(30) Foreign Application Priority Data
Jul. 11, 2006 (TW) 95125313

(51) Int. Cl. H04L 12/28

(52) U.S. Cl. 370/254

(57) ABSTRACT

A method and system for blocking some specific function of a P2P application in the network is disclosed. The method includes the steps of: (a) continually monitoring a plurality of network connections established by a plurality of clients; (b) collecting the packets sent by a P2P application from one of the plurality of clients when one of the plurality of clients establishes the network connection; (c) comparing the lengths of the collected packets; (d) determining a specific function to be performed by the P2P application based on the result of comparison; and (e) blocking the determined specific function of the P2P application.

### RELATED APPLICATIONS

This application claims priority to Taiwan Application Serial Number 95125313, filed Jul. 11, 2006, which is herein incorporated by reference.

### BACKGROUND OF THE INVENTION

1. Field of Invention

The invention relates to a method and system for blocking some specific function of a P2P application in a network. The invention collects the packets sent out by the P2P application and compares the correlations among them, thereby blocking the specific function of the P2P application.

2. Related Art

The development of networks has enabled computers to perform various types of work. For example, two computers can communicate by E-mail and transfer files using a peer-to-peer (P2P) network application. Therefore, it becomes very popular for users to share electronic data using the P2P network application.

The P2P applications are often embedded with various functions to communicate with remote computers. However, there is no effective method for a network administrator to limit some function of the P2P application in order to guarantee network quality. It is known that some P2P applications adopt encrypted transmissions during the communications. Therefore, it is impossible to find feature codes from the payload in order to limit such features. Other methods are thus needed.

It is imperative to provide a method that can find some distinctive information by checking the correlations of packets, thereby blocking some function of the P2P application.

### SUMMARY OF THE INVENTION

The invention provides a method for blocking some specific function of the P2P application (e.g., the commonly seen Skype application) in a network.

In an embodiment of the invention, the method of clocking some specific function of the P2P application in a network includes: a monitoring step, which continually monitors a plurality of network connections established by a plurality of clients; a collecting step, which collects the packets sent out by a P2P application from one of the clients when the network connection thereof is established; a packet comparing step, which compares the lengths of the collected packets; a determining step, which determines a specific function to be performed by the P2P application based upon the result of length comparison; and a blocking step, which blocks the determined specific function of the P2P application.

In an embodiment of the invention, the network connection can be a TCP or UDP connection.

In another embodiment of the invention, the network connection can be a first connection or a non-first connection. Here the first connection refers to the network connection established between one of the clients and another during the first communication. The non-first connection refers to the network connection between the above-mentioned two parties after their first connection. Moreover, if the non-first connection does not work for a while, it goes back to the first connection method for further communications.

In yet another embodiment of the invention, the packet comparing step performs the comparison in the first connection or the non-first connection.

In the First Connection:

The lengths of the first to the third packets in the collected packets are compared. According to the packet length comparison result, the invention determines whether one of the clients is using one of the functions of the P2P application. The invention further compares the lengths of the seventh and eighth packets in the collected packets. Based upon the latter packet length comparison result, the invention determines the specific function to be performed by the P2P application.

In the Non-First Connection:

The lengths of the first to the third packets in the collected packets are compared. According to the packet length comparison result, the invention determines the specific function to be performed by the P2P application.

In one embodiment of the invention, the packet comparing step includes: a doubting step, which is performed at the same time as comparing the packet lengths, doubts the specific P2P application function when the packet length satisfies a condition for the client P2P application to perform the specific function, and records a client address to a list of specific P2P application functions to be blocked. Besides, when farther comparing the packet lengths, if the P2P application of the client is determined not to perform the specific P2P application function, then the address thereof is taken off the blocking list.

In one embodiment of the invention, the specific P2P application function blocking list can be manipulated as a criterion for blocking the specific function of the P2P application.

In another embodiment of the invention, if it is impossible to determine the specific function of the P2P application by comparing the packets during the non-first connection, the specific function is determined when the client receives specific function executing information. The specific function of the P2P application can be a communication behavior, such as a file transfer, and the specific function executing information can be the information for executing the communication behavior.

In one embodiment of the invention, the collected packets are extracted when one of the clients invites another to perform the communication behavior.

The invention also provides a system implemented with the above-mentioned method.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIGS. 1A-1B show screens of packet features detected by the packet monitoring program when Skype is executing the voice talk function;

FIGS. 2A-2E show screens of packet features detected by the packet monitoring program when Skype is executing the message transfer function;

FIGS, 3A-3E show screens of packet features detected by the packet monitoring program when Skype is executing the file transfer function; and

FIG. 4 is a flowchart showing how a specific function of the P2P application is blocked according to an embodiment of the invention.

### DETAILED DESCRIPTION OF THE INVENTION

The present invention will be apparent from the following detailed description, which proceeds with reference to the accompanying drawings, wherein the same references relate to the same elements.

The Skype program is used in this specification as an explicit example of P2P application to illustrate the technical features of the invention. A person skilled in the art can readily understand that any application with the features mentioned in the specification should be construed as part of the invention.

The Skype P2P application has three important functions: voice talk, file transfer, and message transfer. To maintain quality of the network, it is often unable to effective restrict the use of some specific function of the P2P application. For example, one cannot forbid the use of file transfer in Skype. Based upon the features of various packets extracted when Skype tries to establish network connections, the invention analyzes to determine which function is being used by the application and blocks it.

In an embodiment of the invention, the invention continually monitors several network connections established by several clients. For example, the TCP or UDP connections established by individual clients are continually monitored.

Analysis of Packet Features when Executing a Specific Function

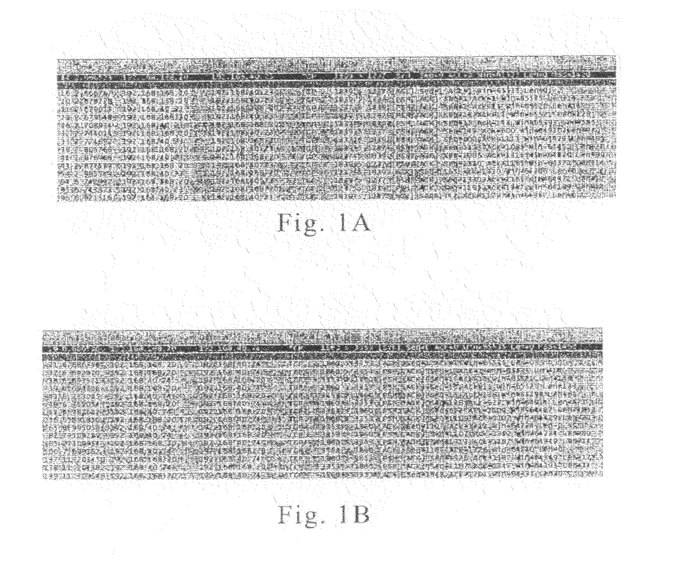

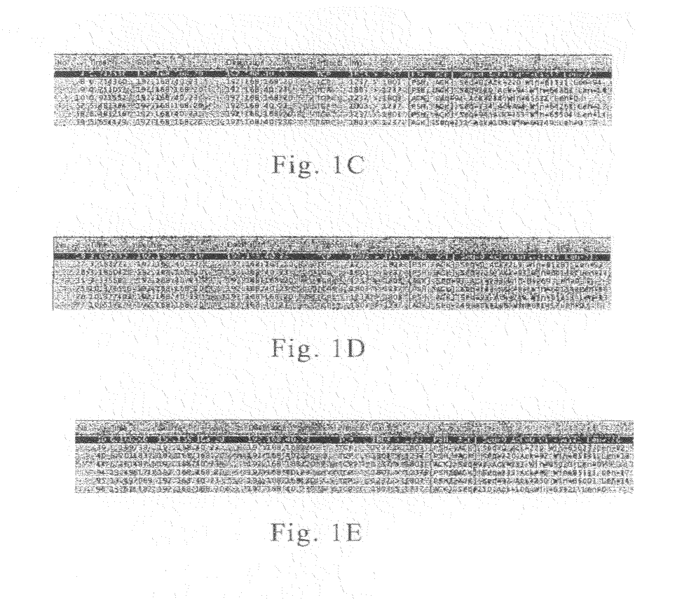

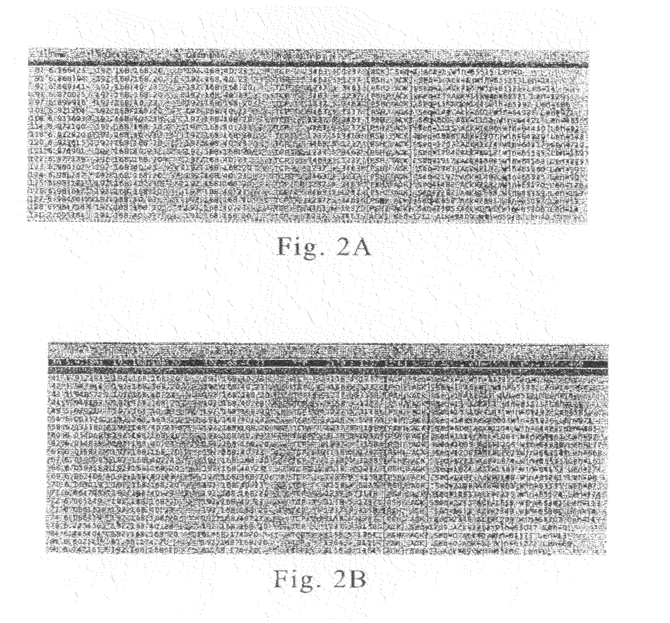

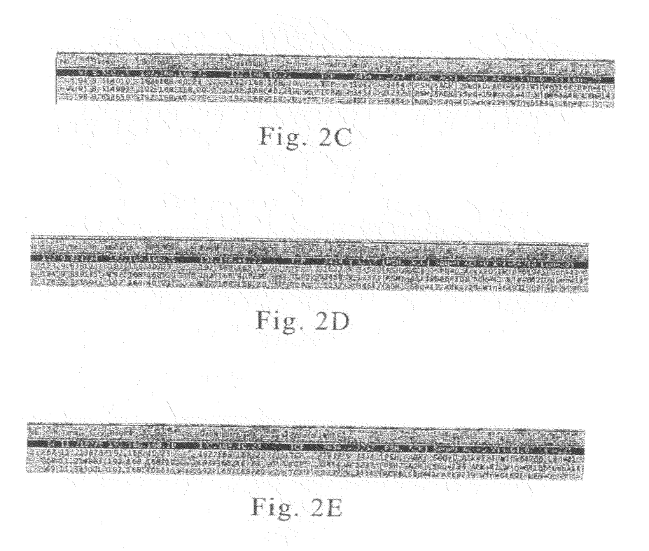

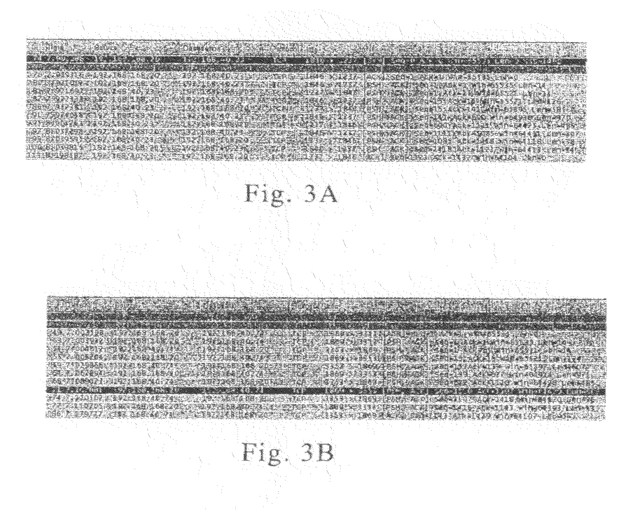

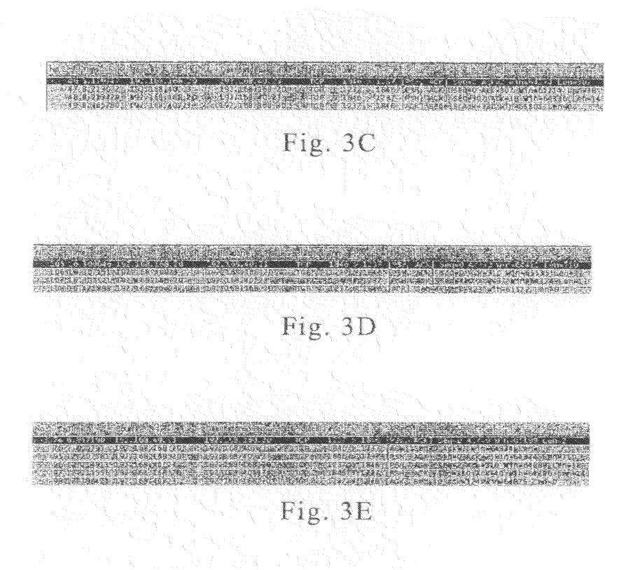

FIGS. 1A-1E show the packet features when Skype is executing the voice talk function as detected by a packet monitoring program. FIGS. 2A-2E show the packet features when Skype is executing the message transfer function as detected by a packet monitoring program. FIGS. 3A-3E show the packet features when Skype is executing the file transfer function as detected by a packet monitoring program.

Based upon features in the packets, the invention finds their Correlations in order to determine which function is to be performed by the P2P application. For example, the invention can determine from the features of the packets whether Skype is performing the voice talk, file transfer, or message transfer function. According to FIGS. 1A-1E, 2A-2E, and 3A-3E, the analyses of the packets are divided into first connection and non-first connection. The analyzing details are given in Tables 1, 2, and 3.

During the First Connection:

TABLE 1
Analyzing table of voice talk and file transfer during the first connection.

| Function | Packet No. | | | | | | | | |
|---|---|---|---|---|---|---|---|---|---|
| (Packet Length) | (1) | (2) | (3) | (4) | (5) | (6) | (7) | (8) | (9) |
| Voice Talk | 14 | 14 | 128 | 585 | 970 | 485 | 203 | 80 | 14 |
| Voice Talk | 14 | 14 | 123 | 607 | 971 | 485 | 203 | 80 | 14 |
| Voice Talk | 14 | 14 | 128 | 607 | 974 | 485 | 203 | 80 | 14 |
| File Transfer | 14 | 14 | 126 | 585 | 970 | 485 | 307 | 38 | 14 |
| File Transfer | 14 | 14 | 124 | 607 | 971 | 485 | 306 | 36 | 13 |
| File Transfer | 14 | 14 | 124 | 607 | 971 | 485 | 309 | 38 | 14 |

TABLE 2
Analyzing table of message transfer during the first connection.

| | (1) | (2) | (3) | (4) | (5) | (6) | (7) | (8) | (9) | (10) | (11) | (12) | (13) | (14) | (15) | (16) | (17) |
|---|---|---|---|---|---|---|---|---|---|---|---|---|---|---|---|---|---|
| Message | 14 | 14 | 128 | 586 | 970 | 485 | 92 | 137 | 668 | 162 | 280 | 99 | 608 | 56 | 56 | 13 | 13 |
| Message | 14 | 14 | 128 | 585 | 971 | 485 | 92 | 137 | 668 | 161 | 274 | 98 | 87 | 174 | 113 | 54 | 14 |
| Message | 14 | 14 | 129 | 586 | 971 | 485 | 92 | 128 | 710 | 159 | 275 | 99 | 90 | 176 | 113 | 53 | 14 |

During the Non-First Connection;

TABLE 3
Analyzing table of voice talk, file transfer, and message
transfer during the non-first connection.

| Function | Packet No. | | |
|---|---|---|---|
| (Packet Length) | (1) | (2) | (3) |
| Voice Talk | 220 | 94 | 14 |
| Voice Talk | 219 | 93 | 14 |
| Voice Talk | 220 | 92 | 14 |
| File Transfer | 307 | 38 | 14 |
| File Transfer | 310 | 37 | 13 |
| File Transfer | 310 | 38 | 14 |
| Message | 199 | 38 | 14 |
| Message | 205 | 37 | 13 |
| Message | 225 | 38 | 14 |

In an embodiment of the invention, the packets mentioned in the above tables are extracted when one invites another party to use the voice talk, file transfer, or message transfer function. The transmissions in these functions are of two types: the first connection and the non-first connection. Throughout this specification, the first connection refers to the network connection established between one of the clients and another during the first communication. The non-first connection refers to the network connection between the above-mentioned two parties after their first connection. However, if the non-first connection is not active after a specific time, it is changed to the situation that requires the establishment of a first connection.

We here provide an embodiment for analyzing the above-mentioned three functions of Skype. In voice talk, the first connection is fixed to nine packets, whereas the non-first connection is fixed to three packets. In file transfer, the first connection is fixed to nine packets, whereas the non-first connection is fixed to the packets. However, the first packet changes with the length of the filename in a regular way. Suppose the length of the filename is five characters, then the length of the first packet is about 303 bytes. Each additional character increases the packet length by one byte. Each additional Chinese character increases the packet length by three bytes. In message transfer, the number of packets in the first connection is not fixed, but around seventeen. The features in the first six packets are similar to those for voice talk and file transfer. The number of packets in the non-first connection is fixed to three packets. Nonetheless, the length of the first packet varies with the size of the message in a regular way. For example, if the message length is 5 characters, then the length of the first packet is about 200 bytes. Each additional character increases the packet length by one byte. Each additional Chinese character increases the packet length by three bytes. How the length of the first packet is varied with the length of the transferred file or message during the first connection will be described below.

It is seen in the above analyses and tables that the first to the third packets can be used in a first connection to determine whether any function of Skype is being performed. The seventh and eighth packets are then used to determine the specific function of Skype. Although there is no fixed number of packets in the message transfer, the seventh and eighth packets in the first connection are still different from the others. Therefore, it can be recognized. In a non-first connection, the first to third packets can be used to determine the specific P2P application function to be performed by Skype. However, the length of the first packet has a regular variation in the message and file transfers. Therefore, the second packet can be used to distinguish between the voice talk function and the file and message transfer functions. Since the file transfer function and the message transfer function can only be distinguished using the first packet, the invention can determine which specific function of the P2P application is to be performed by checking specific function executing information received by the client in the case when it cannot be determined from the packet comparison. For example, as shown in Table 4, suppose the length of the first packet in the message transfer function of Skype is equal to 111 characters or 37 Chinese characters, it cannot be distinguished from the file transfer function. Therefore, the invention utilizes the information that Skype asks the communicating party to return a storage window during a file transfer to determine that it is using the file transfer function.

TABLE 4
Analyzing table for the exception of file transfer and message transfer.

| | (1) | (2) | (3) |
|---|---|---|---|
| File Transfer | 310 | 38 | 14 |
| Message Transfer | 199 | 38 | 14 |

In the following embodiments, we use the case of blocking the file transfer function for discussions. It is obvious that blocking other functions can be similarly performed without departing from the spirit and scope of the invention.

In another embodiment of the invention, Skype uses UDP as the communication channel. Therefore, the invention also detects what the UDP port of Skype is at each client. For example, when the Skype program is started, it communicates with some specific nodes following the port settings therein. The invention also takes the opportunity to record its connection port. If the user wants to change the connection port, he/she has to restart Skype. Therefore, the new connection port is still recorded during the restart.

In one embodiment of the invention, Skype tries to resend using various achievable sessions after its file transfer function is blocked. Therefore, the invention blocks all Skype actions once it detects that the user is using Skype functions until Skype is restarted.

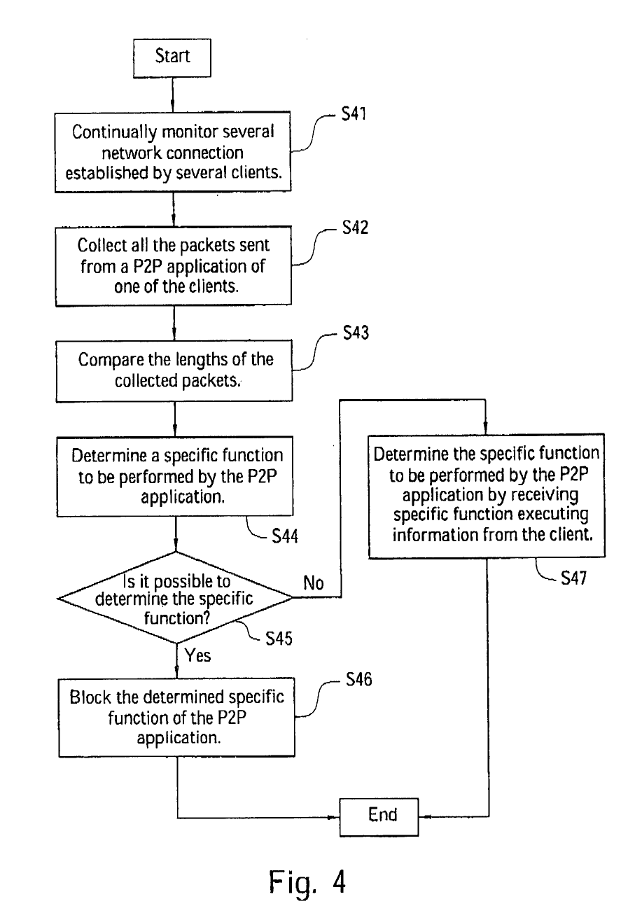

FIG. 4 is a flowchart 400 describing how a P2P application function is blocked according to an embodiment of the invention. To simplify the description, the method is displayed and described as a series of and a number of actions. However, it should be understood that the invention is not limited by the order of the actions. Some actions can be performed at a different order or simultaneously with others. For example, a skilled person should understand that one method can be expressed as a series of interacting states or events. Besides, not all actions in the invention are required for a particular process.

In step S41, the invention continually monitors several network connections (e.g., TCP and UDP connections) established by several clients. In step S42, when one of the clients establishes a network connection, the packets sent by a P2P application of the client are collected. In step S43, the lengths of the packets collected from the P2P application are compared. In step S44, the invention determines a specific function to be performed by the P2P application according to a comparison result of the packet lengths. In step S45, the invention determines whether it is possible to determine the specific P2P application function using the packet comparison. For example, it checks whether there is any exception to the comparison. If there is no exception, then the procedure continues to step S46. Otherwise, the procedure goes to step S47. In step S47 where the comparison does not help, the invention determines the specific P2P application function by receiving specific function executing information from the client. For example, a saving confirmation window information is used to determine the file transfer function in Skype. In step S46, the determined specific function of the P2P application is blocked. For example, the invention blocks the port for file transfers in Skype or all the network connections of Skype.

In accord with the invention, a system implemented with the above-mentioned method for blocking a specific function of a P2P application includes: a monitoring component, a collecting component, a packet comparing component, a determining component, and a blocking component. The monitoring component continually monitors several network connections established by several clients. When one of the Clients establishes the network connection, the collecting component collects all the packets sent out by a P2P application of the client. The packet comparing component compares the lengths, of the collected packets. The determining component determines a specific function of the P2P application to be performed by the P2P application according to a comparison result of the packet lengths. The blocking component blocks the determined specific function of the P2P application.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for blocking a specific function of a peer-to-peer (P2P) application, comprising:
a monitoring step, which continually monitors a plurality of network connections established by a plurality of clients;
a collecting step, which collects packets sent out by the P2P application of one of the clients once the network connection thereof is established;
a packet comparing step, which compares the lengths of the collected packets;
a determining step, which determines a specific function to be performed by the P2P application according to a comparison result of the packet lengths; and
a blocking step, which blocks the determined specific function of the P2P application.

2. The method of claim 1, wherein the network connection is selected from one of the following: a first connection, which is the network connection established between one and another of the clients for a first communication; and a non-first connection, which is the network connection after the first connection is established.

3. The method of claim 2, wherein if the non-first connection is not active for a specific time the network connection is required to be the first connection.

4. The method of claim 3, wherein the packet comparing step in the first connection includes:
the step of comparing the lengths of the first to the third of the collected packets; and
the step of comparing the lengths of the seventh and the eighth of the collected packets.

5. The method of claim 3, wherein the packet comparing step in the non-first connection includes the step of comparing the lengths of the first to the third of the collected packets.

6. The method of claim 4, wherein the determining step further includes:
the step of determining whether the client is using one of the functions provided by the P2P application based on a comparison result of the lengths of the first to the third of the collected packets; and
the step of determining the specific function of the P2P application to be performed based on the comparison result of the lengths of the seventh and the eighth of the collected packets.

7. The method of claim 5, wherein the determining step further includes the step of determining the specific function to be performed by the P2P application based upon a comparison result of the lengths of the first to the third packets.

8. The method of claim 1, wherein the packet comparing step includes a doubting step which is performed at the same time as comparing the packet lengths, doubts the specific P2P application function when the packet length satisfies a condition for the client P2P application to perform the specific function, and records a client address to a blocking list of specific P2P application functions.

9. The method of claim 8, further comprising a clearing step, which clears the address of the client from the blocking list of specific P2P application functions if the specific function of the P2P application is excluded by the packet length comparison result.

10. The method of claim 9, wherein the blocking list of specific P2P application functions is used as a reference for blocking the specific functions of the P2P application.

11. The method of claim 6, further comprising a step of determining a specific function of the P2P application by receiving specific function executing information from the client when the specific function cannot be determined from the packet comparison.

12. The method of claim 1, wherein the network connection is a TCP connection.

13. The method of claim 1, wherein the network connection is a UDP connection.

14. The method of claim 1, wherein the P2P application is Skype.

15. The method of claim 11, wherein the specific function of the P2P application is a communication behavior.

16. The method of claim 15, wherein the communication behavior is a file transfer.

17. The method of claim 15, wherein the collected packets are extracted when one of the clients invites another of the client to perform the communication behavior.

18. The method of claim 15, wherein the specific function executing information is the information for executing the communication behavior.

19. A computer executable system for blocking a specific function of a P2P application, comprising:
a monitoring component, which continually monitors a plurality of network connections established by a plurality of clients;
a collecting component, which collects packets sent out by the P2P application of one of the clients when the network connection thereof is established;
a packet comparing component, which compares the lengths of the collected packets;
a determining component which determines a specific function to be performed by the P2P application according to a comparison result of the packet lengths; and
a blocking component, which blocks the determined specific function of the P2P application.

20. The system of claim 19, wherein the network connection is selected from one of the following: a first connection, which is the network connection established between one and another of the clients for a first communication; and a non-first connection, which is the network connection after the first connection is established.

21. The system of claim 20, wherein if the non-first connection is not active for a specific time the network connection is required to be the first connection.

22. The system of claim 21, wherein the packet comparing component in the first connection compares the lengths of the first to the third of the collected packets and compares the lengths of the seventh and the eighth of the collected packets.

23. The system of claim 20, wherein the packet comparing component in the non-first connection compares the lengths of the first to the third of the collected packets.

24. The system of claim 22, wherein the determining component determines:
whether the client is using one of the functions provided by the P2P application based on a comparison result of the lengths of the first to the third of the collected packets; and
the specific function of the P2P application to be performed based on the comparison result of the lengths of the seventh and the eighth of the collected packets.

25. The system of claim 23, wherein the determining component determines the specific function to be performed by the P2P application based upon a comparison result of the lengths of the first to the third packets.

26. The system of claim 19, wherein the packet comparing component includes a doubting component which performs at the same time as comparing the packet lengths, doubts the specific P2P application function when the packet length satisfies a condition for the client P2P application to perform the specific function, and records a client address to a blocking list of specific P2P application functions.

27. The system of claim 26, further comprising a clearing component, which clears the address of the client from the blocking list of specific P2P application functions if the specific function of the P2P application is excluded by the packet length comparison result.

28. The system of claim 27, wherein the blocking list of specific P2P application functions is used as a reference for blocking the specific functions of the P2P application.

29. The system of claim 24, further comprising a step of determining a specific function of the P2P application by receiving specific function executing information from the client when the specific function cannot be determined from the packet comparison.

30. The system of claim 19, wherein the network connection is a TCP connection.

31. The system of claim 19, wherein the network connection is a UDP connection.

32. The system of claim 19, wherein the P2P application is Skype.

33. The system of claim 29, wherein the specific function of the P2P application is a communication behavior.

34. The system of claim 33, wherein the communication behavior is a file transfer.

35. The system of claim 32, wherein the collected packets are extracted when one of the clients invites another of the client to perform the communication behavior.

36. The system of claim 33, wherein the specific function executing information is the information for executing the communication behavior.
